(19) United States
(12) Patent Application Publication
(10) Pub. No.: US 2003/0038820 A1
(43) Pub. Date: Feb. 27, 2003

(54) Method and apparatus for providing visual security for computer displays

(76) Inventor: William J. Purpura, Anaheim, CA (US)

Correspondence Address: Mark D. Elchuk, Harness Dickey & Pierce P.L.C., P.O. Box 828, Bloomfield Hills, MI, 48303, US

(21) Appl. No.: 09/934,812

(22) Filed: Aug. 22, 2001

(51) Int. Cl. G09G 5/00

(52) U.S. Cl. 345/629

(57) ABSTRACT

A method and apparatus for providing security for user data displayed on a color display screen of a portable computer to prevent viewing of the user data by individuals other than the operator of the computer and who are otherwise positioned to be able to view the display screen. The computer is operated to electronically superimpose an obscuring colored mosaic on the user data while the user data is displayed on the color display screen. The computer can save the user data without the obscuring colored mosaic to an internal storage device, or can fax or print the user data without the obscuring colored mosaic. Specially tinted glasses are used by the operator to allow the obscuring colored mosaic superimposed over the user data to be filtered, and therefore allow only the user to view the user data.

### FIELD OF THE INVENTION

The present invention relates to methods and apparatus for providing privacy for computer systems in cramped environments and more particularly to methods and apparatus for blocking access to information on computer displays to casual onlookers.

### BACKGROUND OF THE INVENTION

Travelers using portable computing devices, such as laptop computers, have difficulty privately operating these devices in public conveyances. For example, a businessperson seated in the middle of a row of seats in a crowded airliner cabin is likely to have difficulty privately reviewing and editing company sensitive data on a laptop computer. The screen of such a computer is likely to be quite legible to an individual in an adjacent seat.

Side screens could be used to block the view of curious or prying individuals who are nearby. However, effective side screens may be undesirably bulky and difficult to attach in some environments. In addition, side screens may interfere with physical access to an individual's own computing device, particularly in crowded environments.

### SUMMARY OF THE INVENTION

To provide security for user data when a computer display screen is utilized in a crowded environment, such as an airplane cabin, one aspect of the present invention is a method for providing security for computer displays. The method includes operating a computer to electronically superimpose an obscuring colored mosaic on user data displayed in a window of an electronic color display, operating the computer to perform at least one of saving the user data without the obscuring colored mosaic, faxing the user data without the colored mosaic, and printing the user data without the obscuring colored mosaic, and providing tinted glasses configured to filter the superimposed colored mosaic displayed in the window of the electronic color display.

In another aspect of the present invention, there is provided a computer-readable medium storing computer executable instructions. The instructions instruct an application program running on a computer to superimpose an obscuring colored watermark on user data displayed in a window of an application program on a color display, and to remove the applied watermark from the user data prior to at least one of printing, faxing, or saving the user data.

In yet another aspect of the present invention, there is provided a computer configured to selectively and electronically superimpose an obscuring colored mosaic on user data displayed on a color display screen, and to display the user data in a color different from that of the obscuring colored mosaic.

Embodiments of the present invention provide simple, yet effective security preventing the content of computer displays from being legible to casual onlookers, such as passengers in adjacent airline seats, and do not require side screens to be attached to the computer display.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of an embodiment of the present invention utilized by a passenger on an airplane.

FIG. 2 is a representation of a prior art display of text or user data on a standard display screen.

FIG. 3 is a representation of the display of text or user data on a display screen obscured by a color mosaic or watermark, as in one embodiment of the present invention. Although not shown in color, FIG. 3 is intended to represent an embodiment utilizing alternating red and white diamonds obscuring blue text. The representation is not drawn to scale, and the diamonds are not necessarily the same size as described in the accompanying description.

FIG. 4 is a simplified flow chart of one embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

As used herein, an “office suite” refers to a collection of business-oriented computer programs. Examples of office suites include the various versions of Microsoft® Office™ (available from Microsoft Corporation, Redmond, Wash.), WordPerfect® Office (available from Corel Corporation, Ottawa, Ontario, Canada), Lotus SmartSuite® (available from Lotus Development Corporation, Cambridge, Mass.), and StarOffice™ (available from Sun Microsystems, Palo Alto, Calif.). Examples of “application programs,” as that term is used herein, include, but are not necessarily limited to, business-oriented computer programs commonly bundled with other business-oriented programs in an office suite, but which may be offered separately. Examples of such programs include word processors, spreadsheets, databases, presentation programs (such as PowerPoint®, available from Microsoft Corporation, Redmond, Wash.). Solely by way of example and not by way of limitation, portions of the description presented herein pertain to embodiments configured for use with Microsoft® Office™, Microsoft® Word™, and/or Visual Basic® (all available from Microsoft Corporation, Redmond, Wash.).

As used herein, the term “application program” also includes individual programs that are not bundled in an office suite. Many such applications programs include a programming environment or macro language similar to that provided by an office suite.

As used herein, “operating a computer” to perform a task such as superimposing a colored obscuring mosaic in a window of a display means to have the computer perform the task, either as an inevitable result of executing a sequence of instructions or as a result of a command entered by a user of the computer (such as via a keyboard or mouse).

As used herein, “user data” and “user information” are synonymous. Both terms refer to data entered or viewed by a user utilizing an application program or an office suite program. For example, text and formatting of a Microsoft Word file is considered “user data” and “user information” as those terms are used herein. A “file” on a computer storage medium contains user data in a machine-readable form.

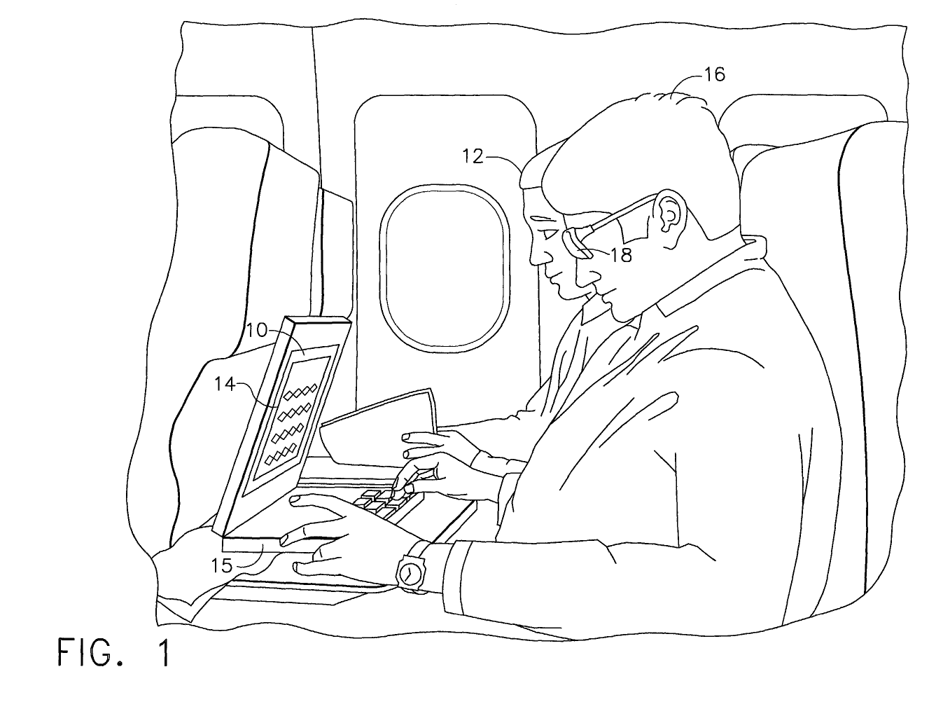

In one embodiment and referring to FIG. 1, a color-based masking method for an electronic color display 10 is provided that effectively limits or prevents a casual onlooker 12 (such as an airline passenger in an adjacent seat) from reading text or other user information appearing in a window 14 displayed on an electronic color display 10 of a computer 15. However, text or other user data in window 14 is readily visible to the computer user 16, who is provided a pair of specially tinted glasses 18 to filter an obscuring color mosaic.

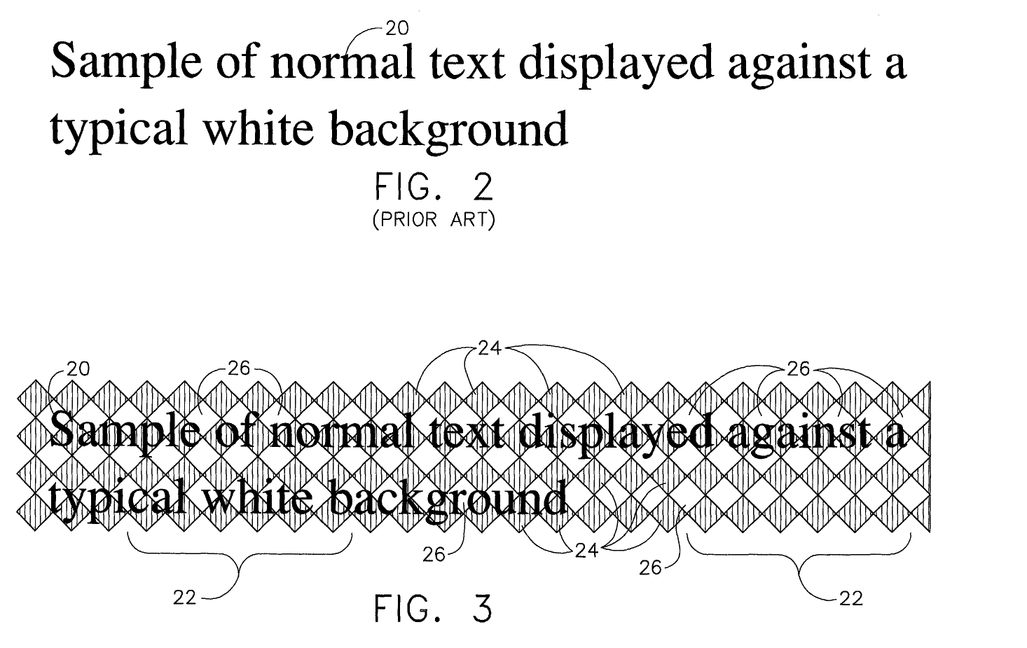

In prior art window displays of application programs and referring to FIG. 2, user data such as black text 20 is displayed on a white background or another background that results in the text being readily visible. By contrast, in one embodiment of the present invention and referring to FIG. 3, however, a colored background 22 is provided that substantially interferes with the legibility of text 20 as seen by the naked eye. For example, background 22 is an obscuring colored mosaic having a pattern and a color selected to substantially interfere with the legibility of text 20. The color of text 20 in one embodiment is also changed to a color selected to decrease legibility in the presence of obscuring colored mosaic 22. For example, text 20 is displayed in a blue color, rather than a black color, and background 22 comprises a mosaic pattern of alternating red diamonds 24 and white diamonds 26 superimposed over text 20. This alternating red and white pattern substantially interferes with the legibility of blue text 20, because the colored, sloping, angular outline of diamonds 24, 26 interferes with attempts by the eye to follow the outline of the letters of text 20. In one embodiment, an area of each diamond 24, 26 is also selected to enhance its disruptive effect. For example, in one embodiment, each white diamond 26 has an area between 20 and 40% of the area of a rectangle defined by the width and height of a specified text character in the font of text 20. The specified text character is “W” or “M” in the font of text 20, when the font of text 20 is a proportional font, or the letter “H,” when the font is a fixed-width font. In another embodiment, the area of each white diamond 26 is between 23 and 27% of the area of the rectangle, and in another embodiment, the area of white diamonds 26 is 25% of the area of the rectangle. In one embodiment, the total area of white diamonds is 25% of the area of window 14, and the total red area is 75% of the area of the window. The total red area comprises a regular array of red “diamonds” 24. Diamonds 24 and 26 are each arranged in regular arrays, and alternate to fill a window 14 of a computer screen 10. The combination of the “diamond” arrays is characterized by having sloping edges that visually disrupt text. (Shapes between closely-spaced diamonds in a regular array are referred to as “diamonds” even though such shapes may differ somewhat from a conventional four-sided geometric diamond. Such differences may occur, for example, when “diamonds” 24 and 26 are of unequal size.)

Referring to FIGS. 1, 2, and 3, to the eye of a casual onlooker 12, a computer screen 10 having a window 14 with a superimposed obscuring colored mosaic background or watermark 22 of red diamonds 24 and white diamonds 26 on user data rendered as blue text 20 appears as an illegible jumble of red, blue, and white areas. However, a set of tinted glasses 18 configured to filter the obscuring effect of the colored mosaic is provided. When user 16 dons a set of red tinted glasses 18 matching the color of red diamonds 24 shown on the screen, the obscuring background mosaic or watermark 22 appears as a solid color that does not obscure user data 20, thus making user data rendered as text 20 clearly legible for reading and/or manipulation. The obscuring colored background mosaic or watermark 22 continues to be superimposed over the rendered user data or text 20 as user 16 manipulates user data displayed on color display 10 such as by scrolling or editing text 20.

Other embodiments of the present invention employ different backgrounds and/or text coloration to achieve the results described above. For example, in one embodiment, background or watermark 22 is a pattern selected for its obscuring effectiveness. In yet another embodiment, the background or watermark 22 color, pattern, and/or size is selectable by user 16, as is the color of text 20 and/or other information being displayed or manipulated.

Some office suites and application programs provide a “watermark” feature that is useful for providing an obscuring background. In Microsoft Office programs such as Word, the watermark feature is accessible in the Visual Basic programming language. Thus, in one embodiment of the present invention, superimposing an obscuring mosaic over user data comprises applying a watermark to user data displayed in a window of an application program. Embodiments of the present invention adapted for use with other programs utilize watermark functions of these other programs, when available, or utilize other methods to provide an obscuring background mosaic.

Although watermarks are saved with Microsoft Office data files, the masking watermark is removed and replaced by the saved watermark (if any) when a document is printed, saved, or faxed. Also, when user 16 turns on masking (i.e., the obscuring watermark), user data is blanked such as by changing the color of the text to white until the obscuring watermark is displayed on the screen. Thus, in one embodiment, superimposing an obscuring mosaic over user data comprises displaying the superimposing mosaic before visibly displaying the user data. User data is also blanked prior to the removal of the obscuring watermark for printing, faxing, or saving a file.

More particularly, in one embodiment of the present invention, a software module written in Visual Basic loads a pull-down menu onto a standard tool bar of a Microsoft Office tool suite. The pull down menu offers the following options, which are provided by Visual Basic instructions that are interpreted and executed by the Visual Basic interpreter provided with the application program:

1. Enable color masking

a. Set masking color

b. Set masking pattern

2. Disable color masking

3. Save data file in original form

4. Save data file and disable color masking

5. Print/Fax clean output

6. Uninstall color masking tool

A user accesses the pull-down menu to open a new or existing file in Microsoft Office application program and to start the privacy system provided by the software module. The software module saves any existing background or watermark setting for the file and then performs a block change or a watermark selection 22 to impose the obscuring colored mosaic mask using the color and/or patterns 24, 26 requested by the user. At this point, user 16 dons a set of tinted glasses 18 matched to the colored mosaic so that he or she can view and work with the data file.

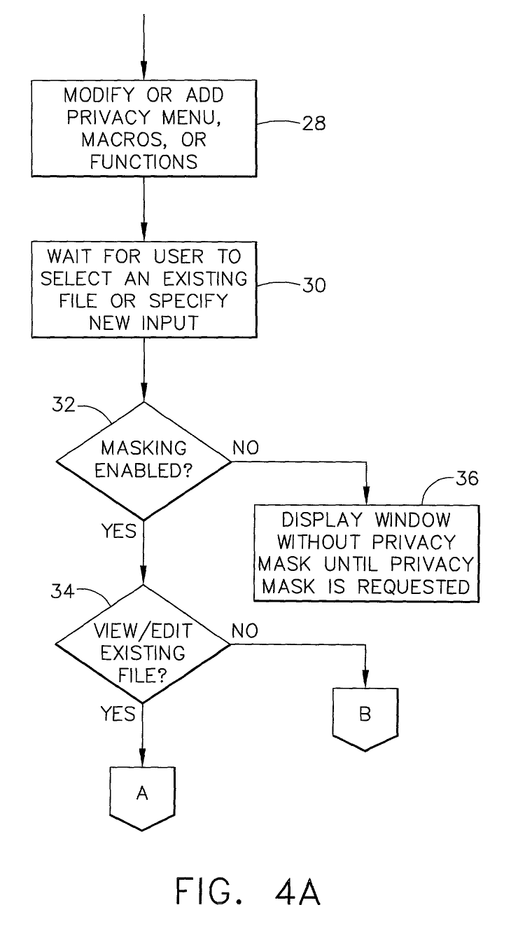

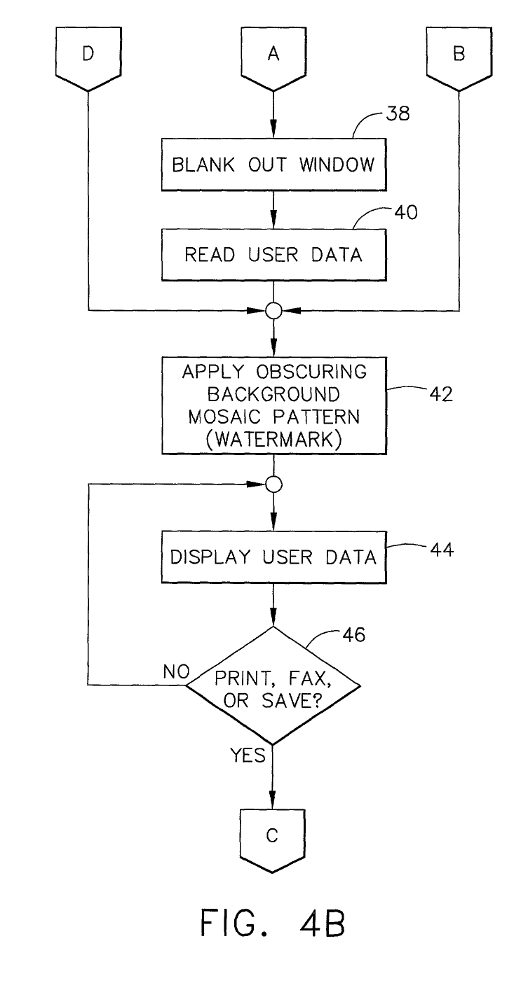

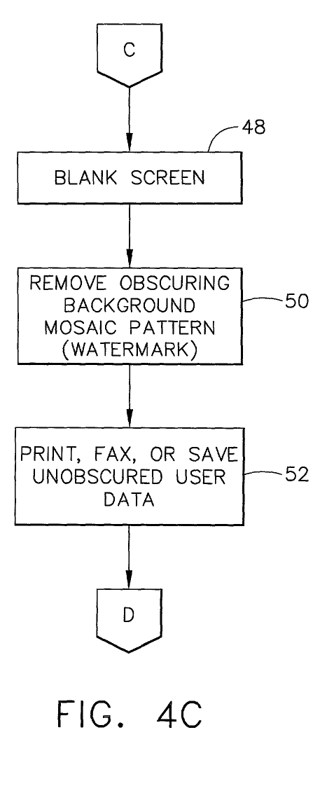

Referring to FIG. 4, the software module loads itself and modifies or adds 28 the menu, macros, or user-accessible functions of the privacy system. This loading occurs either as part of an initial startup sequence performed by the office suite software or as an operation initiated by user 16. In one embodiment, the menu described above is added to the menu bar of an application program under the heading “Privacy.” The application program software then waits 30 for user 16 to select an existing file or to enter new text or other data. (Most office suite application program software is event driven. Thus, although not indicated by FIG. 4, a user is able to request that other software functions be performed while the application program software waits for the selection to be made.)

After the user makes a selection to view or edit an existing file or to input new data, the privacy module code instructs the application software interpreting the privacy module code to determine 32 whether the user has previously selected the “Enable Color Masking” option. If not, the office suite software functions normally 34 without color masking, unless and until the user requests a privacy mask. Otherwise, the privacy module instructs the interpreter to determine 36 whether the user has chosen to view or edit an existing file. If the user has chosen to view or edit an existing file, the office suite window is blanked 38 (for example, utilizing Visual Basic commands) while user data is read 40 from a specified file in storage. An obscuring colored background mosaic or watermark 22 is applied 42 to display window 14 of the office suite software, and then the user data is displayed 44 in an appropriate color in display window 14. In this manner, an obscuring colored mosaic is superimposed on user data displayed in a colored display window of a computer.

If the interpreted privacy module instructions determine 36 that the user has chosen to enter new data into a new file, it is not necessary to blank out the office suite window and read user data from a file in storage. Instead, execution of the privacy module instructions continues with application 42 of the obscuring background mosaic pattern or watermark on a blank display window 14. User data entered by user 16 is displayed 44 in window 14.

A set of tinted glasses configured to filter the colored mosaic is provided to allow user 16 to clearly view user data in display window 14. However, casual onlookers 12 will not be able to easily discern sensitive data on computer screen 10 when the obscuring background appears superimposed on the user data. The obscuring background mosaic pattern or watermark continues to be superimposed on the user data as user 16 manipulates the data in display window 14.

In one embodiment, one or more special versions of save, print, and/or fax commands are provided for selection by user 16. When one of these special commands is selected 46, instructions in the privacy module are interpreted which cause blanking 48 of display window 14, followed by instructions that remove 50 the obscuring background mosaic pattern or watermark. Depending upon which of the special commands was selected by user 16, the privacy module then instructs the interpreter to save 52 the user data to storage, fax the user data to a remote location, or print the user data. However, prior to saving, faxing, or printing, the original color of the user data to be saved, faxed or printed is restored, along with any original, user-selected background or watermark. After printing, saving, or faxing 52 the user data, the obscuring background or watermark mosaic pattern is restored 42 to window 14, and the user data 44 is then displayed (in a masking color, for example, blue text for use a with alternating red and white diamond mosaic) for additional work and viewing. After user 16 is finished with the file, he or she can close window 14 using an existing office suite software or operating system command. The privacy module is configured so that in case of a computer system failure or software error, the data file retains any original, user-selected background rather than the obscuring mosaic or watermark.

In one embodiment, a choice of masking color combinations for the obscuring color mosaic background or watermark and the user data is provided by the privacy module software. This choice allows different users seated near one another to simultaneously utilize embodiments of the present invention. For example, the privacy module provides a choice between red, green and blue for diamonds 24. Depending upon the color selected, the privacy module also activates a contrasting text color. For each color choice, a corresponding set of colored glasses is provided. By using distinct masking color schemes for the obscuring background mosaic or watermark, nearby users can operate their own computers while maintaining privacy from each other and from other individuals.

One embodiment of the present invention comprises machine-readable computer instructions on diskette, compact diskette (e.g., a CD-ROM) or other suitable medium. In another embodiment, computer instructions are electronically communicated to a computer via a modem, the Internet, or other computer communication network, such as a network on an aircraft providing services for passengers' equipment.

In one embodiment, a single lens frame with a set of interchangeable colored lenses, such as red, green, and blue, is provided. For example, sets of red, green, and blue lenses are provided in one embodiment, and selected in accordance with a color selected for the obscuring color mosaic.

In one embodiment, the software for a passenger's computer is provided by the airline company, either via an electronic network or via machine-readable media provided by a flight attendant. Also in one embodiment, the flight attendant also provides appropriate masking glasses or lenses and frames.

Embodiments of the present invention may include computer instructions that search for all office-type applications, and to install itself as part of the basic toolbar of each such program found. A capability for a user to uninstall the software may be provided.

Embodiments of the present invention are not limited to Microsoft programs or to Microsoft Office-type programs. More particularly, embodiments of the invention are useful in conjunction with a wide variety of programs that can be utilized in conjunction with a color display. The shapes, sizes, and/or colors of the obscuring background mosaic are different in some embodiments to provide for the most effective masking of different program outputs or output screens.

In another embodiment, the capability for displaying a masking background mosaic is provided in hardware. For example, a display card in a personal computer is provided with display adapter hardware and/or firmware to display a background mosaic over an entire computer screen 10, and a special key or combination of keys is provided to selectively activate or deactivate the masking mosaic. When the obscuring colored mosaic is activated, it is superimposed on displayed user data, which the display adapter is configured to display in a color different from that of the obscuring mosaic.

Embodiments of the present invention can readily be used or adapted for use with laptop computers, desktop computers, display terminals, and special purpose computers and calculators, and are useful in conjunction with color displays of all types, including, but not limited to, cathode ray tube (CRT) displays, liquid crystal displays, and plasma displays. In each of the different embodiments, a user is able to view and/or manipulate sensitive data that is obscured from casual observers. Embodiments of the present invention are particularly useful, for example, for airline passengers who may otherwise not want to put sensitive business data on view for other passengers to see and who may not want to bother with attaching side screens to their laptop computers while in flight.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for providing security for computer displays comprising:
operating a computer to electronically superimpose an obscuring colored mosaic on user data displayed in a window of an electronic color display;
operating the computer to perform at least one of saving the user data without the obscuring colored mosaic, faxing the user data without the obscuring colored mosaic, and printing the user data without the obscuring colored mosaic; and
providing glasses operable to filter the superimposed, obscuring colored mosaic displayed in the window of the electronic color display.

2. A method in accordance with claim 1 wherein said operating the computer to superimpose an obscuring mosaic on user data comprises operating the computer to apply a watermark to the user data displayed in the window.

3. A method in accordance with claim 2 wherein said operating the computer to superimpose an obscuring mosaic on the user data comprises operating the computer to display the superimposing mosaic before visibly displaying the user data.

4. A method in accordance with claim 2 wherein said operating the computer to perform at least one of saving the user data without the obscuring colored mosaic, faxing the user data without the obscuring colored mosaic, and printing the user data without the obscuring colored mosaic comprises operating the computer to remove the applied watermark from the user data prior to at least one of printing, faxing, and saving the user data.

5. A method in accordance with claim 4 further comprising operating the computer to blank the window prior to removing the applied watermark.

6. A method in accordance with claim 4 further comprising operating the computer to reapply a watermark originally stored with the user data prior to at least one of printing the user data, faxing the user data, and saving the user data.

7. A method in accordance with claim 1 wherein the user data is text, and operating the computer to superimpose a colored mosaic comprises operating the computer to superimpose an array of diamonds of alternating colors on the text.

8. A method in accordance with claim 7 further comprising selecting an area of each of the diamonds sufficient to confuse the eye when the colored mosaic is superimposed upon the text.

9. A method in accordance with claim 8 wherein the diamonds are red and white, and the text is blue.

10. A method in accordance with claim 9 wherein the white diamonds each have an area between 20 and 40% of an area defined by a specified text character in the font of the text.

11. A method in accordance with claim 10 wherein the white diamonds each have an area between 23 and 27% of an area defined by a specified text character in the font of the text.

12. A method in accordance with claim 11 wherein the white diamonds each have an area of 25% of an area defined by a specified text character in the font of the text.

13. A method in accordance with claim 12 wherein a total area of the white diamonds is 25% of a total area of the window, and a total area of the red diamonds is 75% of a total area of the window.

14. A method in accordance with claim 1 further comprising providing a choice of colors for the obscuring colored mosaic, and providing a plurality of sets of colored glasses corresponding to the color choices.

15. A method in accordance with claim 1 further comprising providing a choice of colors for the obscuring colored mosaic, and providing a lens frame with a set of interchangeable colored lenses corresponding to the color choices.

16. A computer-readable medium storing computer executable instructions to instruct an application program to:
superimpose an obscuring colored watermark on user data displayed in a window of an application program on an electronic color display; and
remove the superimposed obscuring watermark from the user data prior to at least one of printing the user data, faxing the user data, or saving the user data.

17. A computer readable medium in accordance with claim 16 and further storing executable instructions to instruct the application program to display the superimposed obscuring colored watermark before visibly displaying the user data.

18. A computer readable medium in accordance with claim 16 and further storing executable instructions to instruct the application program to reapply a watermark originally stored with the user data prior to at least one of printing the user data, faxing the user data, and saving the user data.

19. A computer readable medium in accordance with claim 16 and further storing executable instructions to accept a choice of color for the superimposed obscuring colored watermark.

20. A computer configured to selectively and electronically superimpose a obscuring colored mosaic on user data displayed on an electronic color display screen, and to display the user data in a color different from that of the obscuring colored mosaic.
